(19) United States
(12) Patent Application Publication
(10) Pub. No.: US 2009/0028452 A1
(43) Pub. Date: Jan. 29, 2009

(54) IMAGE DECODING METHOD, IMAGE DECODING DEVICE, AND PROGRAM

(75) Inventor: Takahiro Kimoto, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 11/912,539

(22) PCT Filed: Apr. 25, 2006
(86) PCT No.: PCT/JP2006/308656

§ 371 Date: Oct. 25, 2007

(30) Foreign Application Priority Data
Apr. 27, 2005 (JP) 2005-130282

(51) Int. Cl. G06K 9/46; G06K 9/36

(52) U.S. Cl. 382/238; 382/240

(57) ABSTRACT

A lower hierarchical decoder (100) decodes lower hierarchical data (1001), and creates a lower hierarchical dummy image (1007). A switch (108) accepts a signal (1100) indicating which of the upper and lower hierarchies is to be decoded, and switches a filter processing. In case the lower hierarchy is decoded, the switch (108) inputs the lower hierarchical dummy signal (1007) to a filter (106), and creates an output image. In case the upper hierarchy is outputted, the switch (108) inputs the lower hierarchical dummy signal (1007) to a simple filter (107). With reference to a lower hierarchical pseudo decoded signal (1009) outputted by the simple filter (107), an upper hierarchical decoder (200) decodes upper hierarchical data (2000), and then creates the output image by multiplying with by a filter (206).

### APPLICABLE FIELD IN THE INDUSTRY

The present invention relates to an image decoding method and device for decoding image data, and more particularly to an image decoding method, an image decoding device, and a program thereof for decoding hierarchy-encoded image data in respective hierarchies.

### BACKGROUND ART

The so-called hierarchy encoding signifies a technology of hierarchically encoding image data in an order of coarse information to fine information. Encoding an image hierarchically makes it possible to cope with terminals each having a different display resolution and a different a transfer environment on the condition alone that partial addition/deletion is performed for one piece of compressed data. It is thinkable that with a development in Internet, and diversity of an image reproduction environment, the technology of hierarchically encoding an image becomes of importance increasingly.

On the other hand, the high-quality imaging filter process for allowing a distortion of an decoded image to be reduced, which is performed after the conventional decoding process with prediction encoding and frequency conversion, is regarded as important in the technology of encoding an image. As a high-quality imaging filter, there exist the deblocking filter for smoothing a distortion in boundaries of a block that becomes a unit for encoding image data, the deringing filter for reducing a distortion that comes out along a contour portion, the smoothing filter for reducing mosquito noise that comes out due to quantization, the sharpening filter for sharpening a blurry image, and so on. The international standard of the moving image coding scheme, namely, H.264/MPEG-4AVC makes it a rule to make a reference to the image, for which the high-quality imaging filter process has been performed, in inter-frame prediction encoding scheme.

In FIG. 6, a configuration is shown of the hierarchical image decoding device in which the high-quality imaging filter process has been applied to a pyramidal encoding scheme, being a general technique of the hierarchy encoding, which is adopted in MPEG-2 as well.

At first, an entropy decoding unit 101, an inverse quantizing unit 102, and an inverse frequency converting unit 103 perform a process for lower hierarchical data 1001, respectively, and create a prediction error signal 1004. A prediction decoding unit 105 performs a prediction decoding process by making a reference to a lower hierarchical decoded image 1005 filed into a memory 104, and creates a prediction signal 1006. The prediction signal 1006 and the prediction error signal 1004 are added and a lower hierarchical dummy decoded image 1007 is created. By multiplying the lower hierarchical dummy decoded image 1007 by a filter 106, a lower hierarchical decoded image 1008, which becomes an output, is created. The lower hierarchical decoded image 1008, which is filed in the memory 104, is employed for later decoding.

Next, an entropy decoding unit 201, an inverse quantizing unit 202, and an inverse frequency converting unit 203 perform a process for upper hierarchical encoding data 2001, respectively, and create a prediction error signal 2004. A prediction decoding unit 205 performs a prediction decoding process by making a reference to a lower hierarchical decoded image 1010 filed into the memory 104, and an upper hierarchical decoded image 2005 filed into a memory 204, and creates a prediction signal 2006. The prediction signal 2006 and the prediction error signal 2004 are added, and an upper hierarchical dummy decoded image 2007 is created. By multiplying the upper hierarchical dummy decoded image 2007 by a filter 206, an upper hierarchical decoded image 2008, which becomes an output, is created. The upper hierarchical decoded image 2008, which is filed in the memory 204, is employed for later decoding.

### DISCLOSURE OF THE INVENTION

### Problems to be Solved by the Invention

However, the prior art shown in FIG. 6 has the problem that a processing quantity is much. That is, in a process of decoding an image, the high-quality imaging filter process demands much processing quantity. In the conventional prior art, the high-quality imaging filter process is performed not only in an upper hierarchy but also in a lower hierarchy at the time of decoding the upper hierarchy. For this, it follows that more processing quantity is demanded as compare with the case of decoding the image data that has not been hierarchized.

Thereupon, the present invention has been accomplished in consideration of the above-mentioned problems, and an object thereof is to provide an image decoding method, an image decoding device of a hierarchical image, and a program thereof, which enable the processing quantity at the time of decoding the upper hierarchy to be reduced.

### Means for Solving the Problems

The 1st invention for solving the above-mentioned task, which is an image decoding method of decoding hierarchized image data, characterized in: in decoding a lower hierarchy, amplifying a lower hierarchical dummy decoded image obtained by decoding lower hierarchical data by a filter to create a lower hierarchical decoded image; and in decoding an upper hierarchy, amplifying said lower hierarchical dummy decoded image by a simple filter, being a filter obtained by simplifying said filter, to create a lower hierarchical pseudo decoded image, and thereafter decoding upper hierarchical decoding data by making a reference to said lower hierarchical pseudo decoded image.

The 2nd invention for solving the above-mentioned problem, in the above-mentioned 1st invention, is characterized in that the process of decoding one of the lower hierarchical data and the upper hierarchical data comprises: a process of filing a decoded image; and a prediction decoding process of performing prediction decoding by making a reference to said filed decoded image.

The 3rd invention for solving the above-mentioned problem, in the above-mentioned 1st or 2nd inventions, is characterized in that the filter smoothes boundaries of a block that becomes a unit for encoding image data.

The 4th invention for solving the above-mentioned task, which is an image decoding method of decoding hierarchized image data, characterized in: in decoding a lower hierarchy, amplifying a lower hierarchical dummy decoded image obtained by decoding lower hierarchical data by a filter to create a lower hierarchical decoded image; and in decoding an upper hierarchy, decoding upper hierarchical decoding data by making a reference to said lower hierarchical dummy decoded image.

The 5th invention for solving the above-mentioned problem, in the above-mentioned 4th invention, is characterized in that the process of decoding one of the lower hierarchical data and the upper hierarchical data comprises: a process of filing a decoded image; and a prediction decoding process of performing prediction decoding by making a reference to said filed decoded image.

The 6th invention for solving the above-mentioned problem, in the above-mentioned 4th or 5th inventions, is characterized in that the filter smoothes boundaries of a block that becomes a unit for encoding image data.

The 7th invention for solving the above-mentioned task, which is an image decoding method of decoding hierarchized image data, said image decoding method comprising: a step of filing a lower hierarchical decoded image into a first memory; a first entropy decoding step of entropy-decoding lower hierarchical data: a first inverse quantizing step of inverse-quantizing an output of said first entropy decoding step; a first inverse frequency converting step of performing an inverse frequency conversion for an output of said first inverse quantizing step; a first prediction decoding step of performing a prediction decoding process by making a reference to the image filed into said first memory and an output of said first inverse frequency converting step; a first filter step of performing a filter process for an output of said first prediction decoding step, and outputting a lower hierarchical decoded image; a simple filter step of performing a process of the filter, being a filter obtained by simplifying the first filter, for an output of said first prediction decoding step, and creating a lower hierarchical pseudo decoded image; a step of inputting an output of said first prediction decoding step into one of said first filter and said simple filter by making a reference to a decoding hierarchy instruction signal, being a signal indicating whether or not the hierarchy being output is an upper hierarchy; a step of filing an upper hierarchical decoded image into a second memory; a second entropy decoding step of entropy-decoding upper hierarchical data: a second inverse quantizing step of inverse-quantizing an output of said second entropy decoding step; a second inverse frequency converting step of performing an inverse frequency conversion for an output of said second inverse quantizing step; a second prediction decoding step of performing a prediction decoding process by making a reference to the lower hierarchical decoded image filed into said first memory, the upper hierarchical decoded image filed into said second memory and an output of said second inverse frequency converting step; and a second filter step of performing a filter process for an output of said second prediction decoding step, characterized in: in a case of assuming the lower hierarchical image to be an output image, outputting a lower hierarchical decoded image obtained by amplifying an output of said first prediction decoding step by said first filter, and filing it into said first memory; and in a case of assuming the upper hierarchical image to be an output image, filing a lower hierarchical pseudo decoded image obtained by amplifying an output of said first prediction decoding step by said simple filter into said first memory, and making a reference hereto in the upper hierarchical decoding process.

The 8th invention for solving the above-mentioned task, which is an image decoding method of decoding hierarchized image data, said image decoding method comprising: a step of filing a lower hierarchical decoded image into a first memory; a first entropy decoding step of entropy-decoding lower hierarchical data: a first inverse quantizing step of inverse-quantizing an output of said first entropy decoding step; a first inverse frequency converting step of performing an inverse frequency conversion for an output of said first inverse quantizing step; a first prediction decoding step of performing a prediction decoding process by making a reference to the image filed into said first memory and an output of said first inverse frequency converting step; a first filter step of performing a filter process for an output of said first prediction decoding step, and outputting a lower hierarchical dummy decoded image; a step of determining whether or not to amplify said lower hierarchical dummy decoded image by said first filter by making a reference to a decoding hierarchy instruction signal, being a signal indicating whether or not the hierarchy being output is an upper hierarchy; a step of filing an upper hierarchical decoded image into a second memory; a second entropy decoding step of entropy-decoding upper hierarchical data: a second inverse quantizing step of inverse-quantizing an output of said second entropy decoding step; a second inverse frequency converting step of performing an inverse frequency conversion for an output of said second inverse quantizing step; a second prediction decoding step of performing a prediction decoding process by making a reference to the lower hierarchical decoded image filed into said first memory, the upper hierarchical decoded image filed into said second memory and an output of said second inverse frequency converting step; and a second filter step of performing a filter process for an output of said second prediction decoding step, characterized in: in a case of assuming the lower hierarchical image to be an output image, outputting a lower hierarchical decoded image obtained by amplifying an lower hierarchical dummy decoded image, being an output of said first prediction decoding step, by said first filter, and filing it into said first memory; and in a case of assuming the upper hierarchical image to be an output image, filing a lower hierarchical dummy decoded image, being an output of said first prediction decoding step, in said first memory, and making a reference hereto in the upper hierarchical decoding process.

The 9th invention for solving the above-mentioned task, which is an image decoding device for decoding hierarchized image data, characterized in comprising: a means for, in decoding a lower hierarchy, amplifying a lower hierarchical dummy decoded image obtained by decoding a lower hierarchical data by a filter to create a lower hierarchical decoded image; and a means for, in decoding an upper hierarchy, amplifying said lower hierarchical dummy decoded image by a simple filter, being a filter obtained by simplifying said filter, to create a lower hierarchical pseudo decoded image, and thereafter decoding upper hierarchical decoding data by making a reference to said lower hierarchical pseudo decoded image.

The 10th invention for solving the above-mentioned problem, in the above-mentioned 9th invention, is characterized in comprising: a memory for filing a decoded image; and a prediction decoding unit for performing a prediction decoding process by making a reference to the decoded image filed in said memory.

The 11th invention for solving the above-mentioned problem, in the above-mentioned 9th or 10th inventions, is characterized in that said filter smoothes boundaries of a block that becomes a unit for encoding image data.

The 12th invention for solving the above-mentioned task, which is an image decoding device for decoding hierarchized image data, characterized in comprising: a means for, in decoding a lower hierarchy, amplifying a lower hierarchical dummy decoded image obtained by decoding a lower hierarchical data by a filter to create a lower hierarchical decoded image; and a means for, in decoding an upper hierarchy, decoding upper hierarchical decoding data by making a reference to said lower hierarchical dummy decoded image.

The 13th invention for solving the above-mentioned problem, in the above-mentioned 12th invention, is characterized in comprising: a memory for filing a decoded image; and a prediction decoding unit for performing a prediction decoding process by making a reference to the decoded image filed in said memory.

The 14th invention for solving the above-mentioned problem, in the above-mentioned 12th or 13th inventions, is characterized in that the filter smoothes boundaries of a block that becomes a unit for encoding image data.

The 15th invention for solving the above-mentioned task, which is an image decoding device for decoding hierarchized image data, said image decoding device comprising: a first memory for filing a lower hierarchical decoded image; a first entropy decoding means for entropy-decoding lower hierarchical data: a first inverse quantizing means for inverse-quantizing an output of said first entropy decoding means; a first inverse frequency converting means for performing an inverse frequency conversion for an output of said first inverse quantizing means; a first prediction decoding means for performing a prediction decoding process by making a reference to the image filed into said first memory and an output of said first inverse frequency converting means; a first filter for performing a filter process for an output of said first prediction decoding means, and outputting a lower hierarchical decoded image; a simple filter for performing a process of the filter, being a filter obtained by simplifying the first filter, for an output of said first prediction decoding means, and creating a lower hierarchical pseudo decoded image; a switch for inputting an output of said first prediction decoding means into one of said first filter or said simple filter by making a reference to a decoding hierarchy instruction signal, being a signal indicating whether or not the hierarchy being output is an upper hierarchy; a second memory for filing upper hierarchical decoded image; a second entropy decoding means for entropy-decoding upper hierarchical data: a second inverse quantizing means for inverse-quantizing an output of said second entropy decoding means; a second inverse frequency converting means for performing an inverse frequency conversion for an output of said second inverse quantizing means; a second prediction decoding means for performing a prediction decoding process by making a reference to the lower hierarchical decoded image filed into said first memory, the upper hierarchical decoded image filed into said second memory and an output of said second inverse frequency converting means; and a second filter for performing a filter process for an output of said second prediction decoding means, characterized in: in a case of assuming the lower hierarchical image to be an output image, outputting a lower hierarchical decoded image obtained by amplifying an output of said first prediction decoding means by said first filter, and filing it into said first memory; and in a case of assuming the upper hierarchical image to be an output image, filing a lower hierarchical pseudo decoded image obtained by amplifying an output of said first prediction decoding means by said simple filter into said first memory, and making a reference hereto in the upper hierarchical decoding process.

The 16th invention for solving the above-mentioned task, which is an image decoding device for decoding hierarchized image data, said image decoding device comprising: a first memory for filing a lower hierarchical decoded image; a first entropy decoding means for entropy-decoding lower hierarchical data: a first inverse quantizing means for inverse-quantizing an output of said first entropy decoding means; a first inverse frequency converting means for performing an inverse frequency conversion for an output of said first inverse quantizing means; a first prediction decoding means for performing a prediction decoding process by making a reference to the image filed into said first memory and an output of said first inverse frequency converting means; a first filter for performing a filter process for an output of said first prediction decoding means, and outputting a lower hierarchical dummy decoded image; a determining means for determining whether or not to amplify said lower hierarchical dummy decoded image by said first filter by making a reference to a decoding hierarchy instruction signal, being a signal indicating whether or not the hierarchy being output is an upper hierarchy; a second memory for filing upper hierarchical decoded image; a second entropy decoding means for entropy-decoding upper hierarchical data: a second inverse quantizing means for inverse-quantizing an output of said second entropy decoding means; a second inverse frequency converting means for performing an inverse frequency conversion for an output of said second inverse quantizing means; a second prediction decoding means for performing a prediction decoding process by making a reference to the lower hierarchical decoded image filed into said first memory, the upper hierarchical decoded image filed into said second memory and an output of said second inverse frequency converting means; and a second filter for performing a filter process for an output of said second prediction decoding means, characterized in: in a case of assuming the lower hierarchical image to be an output image, outputting a lower hierarchical decoded image obtained by amplifying a lower hierarchical dummy decoded image, being an output of said first prediction decoding means, by said first filter, and filing it into said first memory; and in a case of assuming the upper hierarchical image to be an output image, filing a lower hierarchical dummy decoded image, being an output of said first prediction decoding means, into said first memory, and making a reference hereto in the upper hierarchical decoding process.

The 17th invention for solving the above-mentioned task, which is a program of an image decoding device for decoding hierarchized image data, characterized in causing said image decoding device to execute: a process of, in decoding a lower hierarchy, amplifying a lower hierarchical dummy decoded image obtained by decoding lower hierarchical data by a filter to create a lower hierarchical decoded image; and a process of, in decoding an upper hierarchy, amplifying said lower hierarchical dummy decoded image by a simple filter, being a filter obtained by simplifying said filter, to create a lower hierarchical pseudo decoded image, and thereafter decoding upper hierarchical decoding data by making a reference to said lower hierarchical pseudo decoded image.

The 18th invention for solving the above-mentioned task, which is a program of an image decoding device for decoding hierarchized image data, characterized in causing said image decoding device to execute: a process of, in decoding a lower hierarchy, amplifying a lower hierarchical dummy decoded image obtained by decoding lower hierarchical data by a filter to create a lower hierarchical decoded image; and a process of, in decoding an upper hierarchy, decoding upper hierarchical decoding data by making a reference to said lower hierarchical dummy decoded image.

In a case of outputting the upper hierarchical decoded image by adopting such an operation, simplifying the high-quality imaging filter in the lower hierarchy makes it possible to achieve an object of the present invention.

### EFFECT OF THE INVENTION

In accordance with the present invention, the usual high-quality imaging filter process is performed in a case of outputting the lower hierarchical decoded image, and the high-quality imaging filter process in the lower hierarchy is simplified in a case of outputting the upper hierarchical decoded image. This makes it possible to reduce the processing quantity that is required for the high-quality imaging filter process in decoding the upper hierarchy.

### BRIEF DESCRIPTION OF THE DRAWINGS

FIG. 1 is a block diagram illustrating a configuration of the best mode for carrying out the first invention of the present invention.

FIG. 2 is a flowchart illustrating an operation of the best mode for carrying out the first invention.

FIG. 3 is a block diagram illustrating a configuration of the best mode for carrying out the second invention of the present invention.

FIG. 4 is a flowchart illustrating an operation of the best mode for carrying out the second invention.

FIG. 5 is a block diagram illustrating a configuration of the image decoding device, being a specific example of the present invention.

FIG. 6 is a block diagram illustrating a configuration of the conventional hierarchical image decoding device.

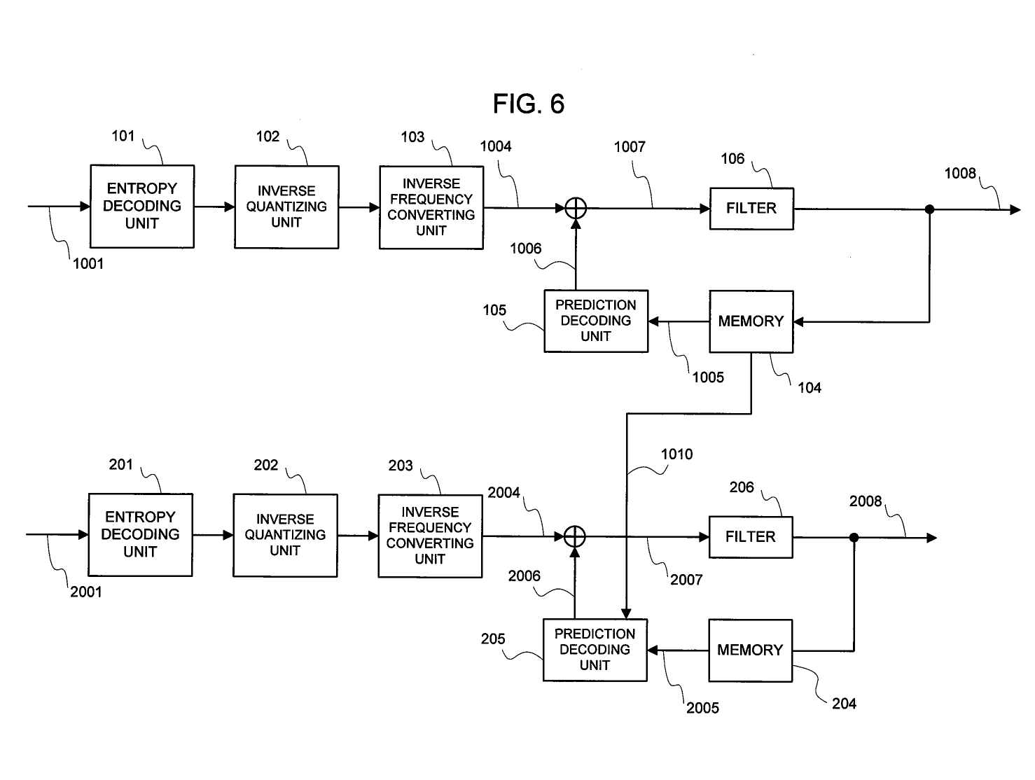

### DESCRIPTION OF NUMERALS

100 lower hierarchical decoder
200 upper hierarchical decoder
101 and 201 entropy decoding units
102 and 202 inverse quantizing units
103 and 203 inverse frequency converting units
104 and 204 memories
105 and 205 prediction decoding units
106 and 206 filters
107 simple filter
108 switch
1001 lower hierarchical data
2001 upper hierarchical data
1002 quantization coefficient signal
1003 coefficient signal
1004 prediction error signal
1006 prediction signal
1007 lower hierarchical dummy decoded image
2007 upper hierarchical dummy decoded image
1005 and 1008 lower hierarchical decoded images
2008 upper hierarchical decoded image
1009 lower hierarchical pseudo decoded image
1100 decoding hierarchy instruction signal

### BEST MODE FOR CARRYING OUT THE INVENTION

The best mode for carrying out the first invention of the present invention will be explained by employing the accompanied drawings.

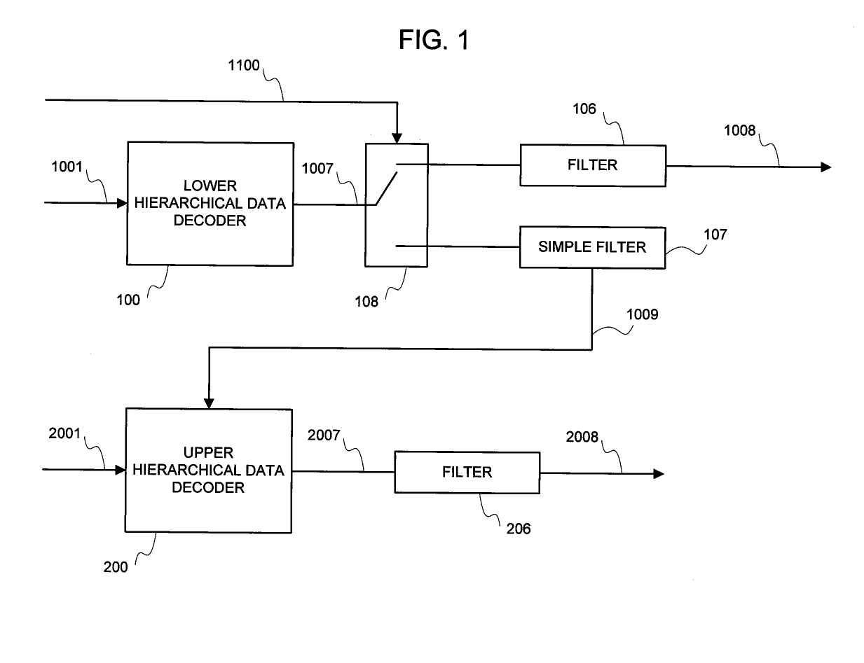

FIG. 1 is a block diagram illustrating a configuration of the image decoding device, being a first embodiment of the present invention.

The hierarchical image decoding device in the present invention is comprised of a lower hierarchical data decoder 100, an upper hierarchical data decoder 200, filters 106 and 206, a simple filter 107, and a switch 108.

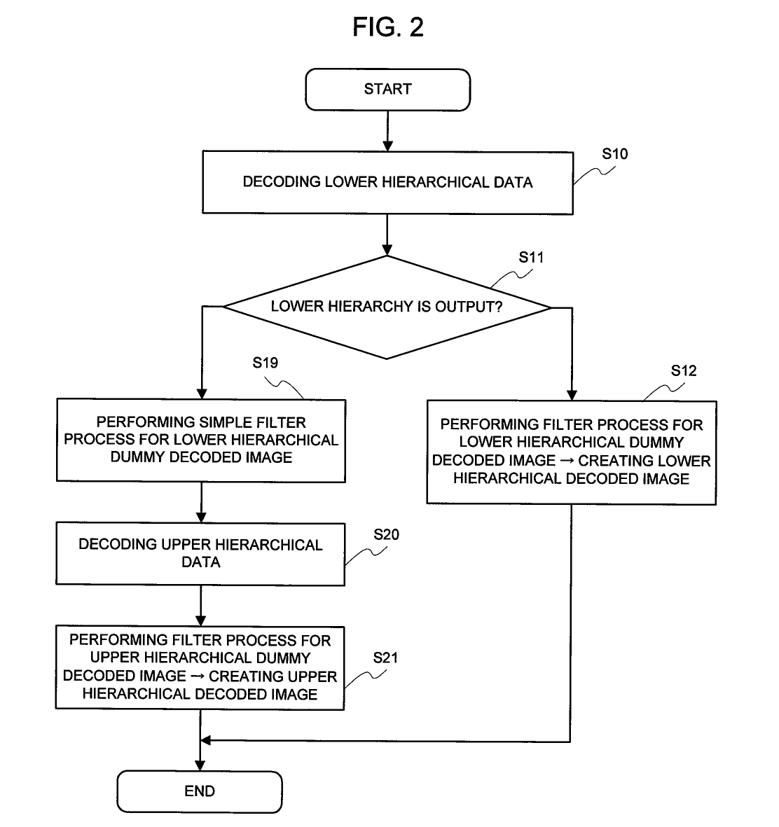

FIG. 2 is a flowchart illustrating a flow of a process up to the output of the decoded image in the image decoding device shown in FIG. 1. All operations of this embodiment will be explained by employing FIG. 1 and FIG. 2.

The lower hierarchical decoder 100 decodes lower hierarchical data 1001, and creates a lower hierarchical dummy decoded image 1007 (S10 of FIG. 2). The switch 108 accepts a decoding hierarchy instruction signal 1100 indicating which of the upper and lower hierarchies the hierarchical image decoding device decodes, and switches the filter process (S11 of FIG. 2). In a case of decoding the lower hierarchy, the switch 108 inputs the lower hierarchical dummy decoded image 1007 into the filter 106. With the filter 106, a lower hierarchical decoded image 1008 is output (S12 of FIG. 2).

In a case of outputting the upper hierarchy, the switch 108 inputs the lower hierarchical dummy decoded image 1007 into the simple filter 107. With the simple filter 107, a lower hierarchical pseudo decoded image 1009 is output (S19 of FIG. 2). The upper hierarchical decoder 200 decodes an upper hierarchical data 2001 by making a reference to the lower hierarchical pseudo decoded image 1009, and creates an upper hierarchical dummy decoded image 2007 (S20 of FIG. 2). By amplifying the upper hierarchical dummy decoded image 2007 by the filter 206, an upper hierarchical decoded image 2008, which becomes an output, is created (S21 of FIG. 2).

In this embodiment, the processing quantity can be reduced because a configuration is made so that not the filter 106, but the simple filter 107 works in decoding the upper hierarchy.

Next, the best mode for carrying out the second invention of the present invention will be explained by employing the accompanied drawings.

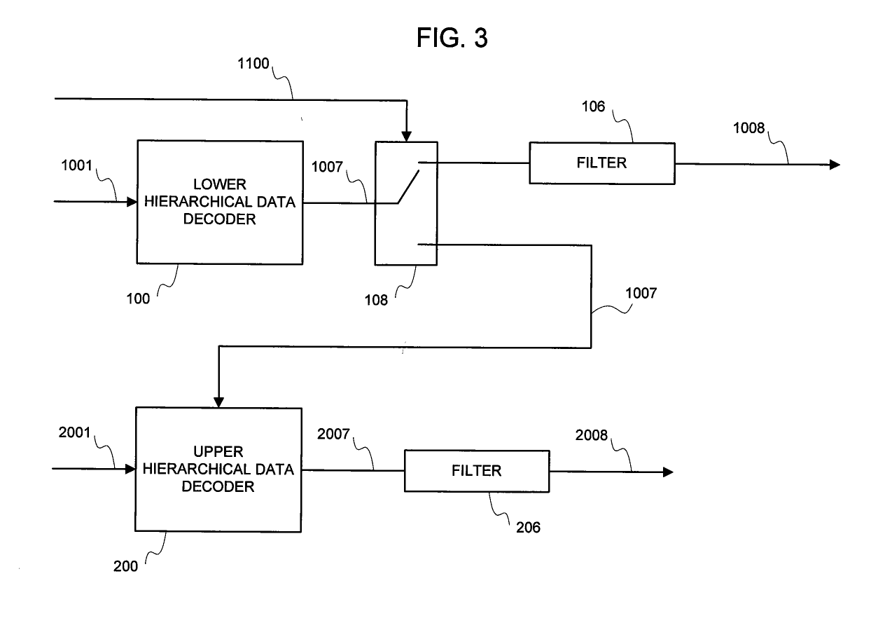

FIG. 3 is a block diagram illustrating a configuration of the image decoding device, being a second embodiment of the present invention.

The hierarchical image decoding device in the present invention is comprised of a lower hierarchical data decoder 100, an upper hierarchical data decoder 200, filters 106 and 206, and a switch 108.

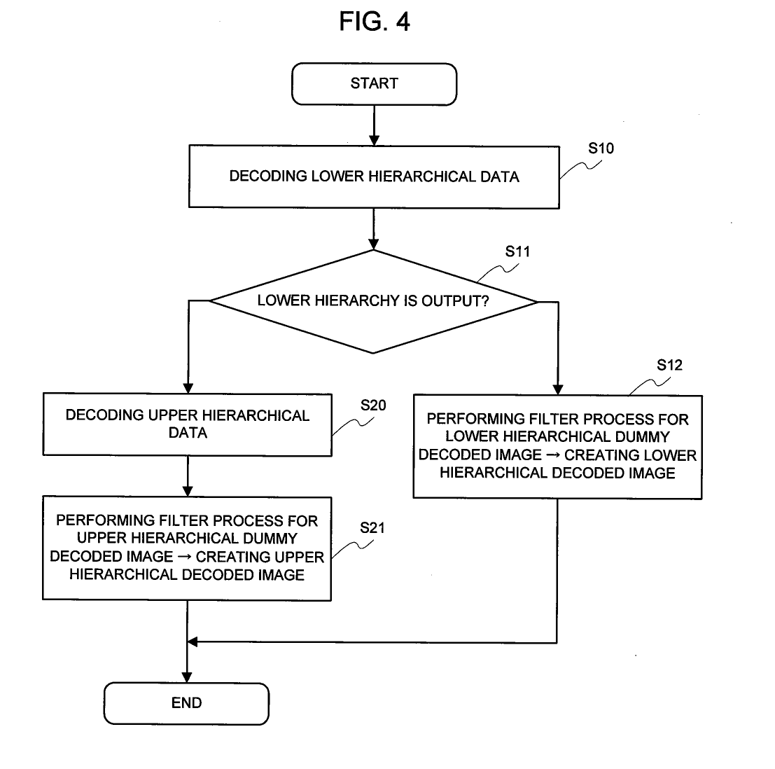

FIG. 4 is a flowchart illustrating a flow of a process up to the output of the decoded image in the image decoding device shown in FIG. 3. All operations of this embodiment will be explained by employing FIG. 3 and FIG. 4.

The lower hierarchical decoder 100 decodes lower hierarchical data 1001, and creates a lower hierarchical dummy decoded image 1007 (S10 of FIG. 4). The switch 108 accepts a decoding hierarchy instruction signal 1100 indicating which of the upper and lower hierarchies the hierarchical image decoding device decodes, and makes a switchover as to whether to perform a filter process (S11 of FIG. 4).

In a case of decoding the lower hierarchy, the switch 108 inputs the lower hierarchical dummy decoded image 1007 into the filter 106. With filter 106, a lower hierarchical decoded image 1008 is output (S12 of FIG. 4).

In a case of outputting the upper hierarchy, the switch 108 directly inputs the lower hierarchical dummy decoded image 1007 into the upper hierarchical decoder. The upper hierarchical decoder 200 decodes the upper hierarchical data 2001 by making a reference to the lower hierarchical dummy decoded image 1007, and creates an upper hierarchical dummy decoded image 2007 (S20 of FIG. 4). By amplifying the upper hierarchical dummy decoded image 2007 by the filter 206, an upper hierarchical decoded image 2008, which becomes an output, is created (S21 of FIG. 4).

In this embodiment, the processing quantity can be reduced because the process by the filter 106 is not performed in decoding the upper hierarchy.

### EXAMPLE 1

Next, the best mode for carrying out the present invention will be explained by employing a specific example.

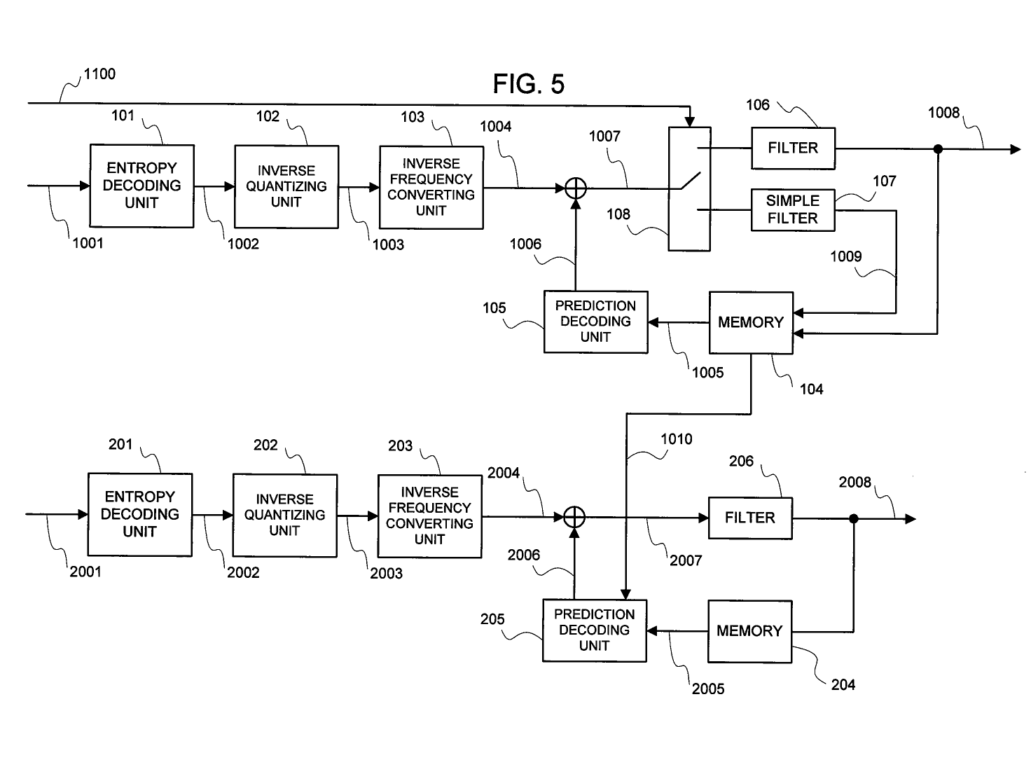

FIG. 5 is a block diagram illustrating a configuration of the image decoding device, being an example of the present invention. The image decoding device in FIG. 5 is comprised of entropy decoding units 101 and 201, inverse quantizing units 102 and 202, inverse frequency converting units 103 and 203, memories 104 and 204, prediction decoding units 105 and 205, filters 106 and 206, a simple filter 107, and a switch 108.

The entropy decoding unit 101, the inverse quantizing unit 102, the inverse frequency converting unit 103, the memory 104, and the prediction decoding unit 105 in FIG. 5 is equivalent to the lower hierarchical decoder 100 in FIG. 1. Further, the entropy decoding unit 201, the inverse quantizing unit 202, and the inverse frequency converting unit 203, the memory 204, and the prediction decoding unit 205 in FIG. 5 is equivalent to the upper hierarchical decoder 200 in FIG. 1.

Hereinafter, a detailed operation of the example in the present invention will be explained by employing FIG. 5.

The entropy decoding unit 101 entropy-decodes the lower hierarchical data 1001, and creates a quantization coefficient signal 1002. The inverse quantizing unit 102 inverse-quantizes the quantization coefficient signal 1002, and creates a coefficient signal 1003. The inverse frequency converting unit 103 performs an inverse frequency conversion for the coefficient signal 1003, and creates a prediction error signal 1004.

The prediction decoding unit 105 performs a prediction decoding process by making a reference to the lower hierarchical decoded image 1005 filed into the memory 104 to create a prediction signal 1006. The movement compensating process, which is performed by making a reference to separately-encoded movement information and already-decoded frames, and the intra-frame interpolating process, which is performed by making a reference to already-decoded neighboring pixels within the identical frame, are employed as a prediction decoding process. The prediction signal 1006 and the prediction error signal 1004 are added to create a lower hierarchical dummy decoded image 1007.

The switch 108 switches the filter process responding to the hierarchy being output by making a reference to the decoding hierarchy instruction signal 1100. In a case of outputting the lower hierarchy, the switch 108 inputs the lower hierarchical dummy decoded image 1007 into the filter 106. With the filter 106, the high-quality imaging filter process is performed, and a lower hierarchical decoded image 1008 is output. The lower hierarchical decoded image 1008, which is filed in the memory 104, is employed for later decoding.

Additionally, as a high-quality imaging filter process that the filter 106 performs, the deblocking filter process of smoothing discontinuity of a signal in boundaries of a block that becomes a unit for encoding image data, the deringing filter process of reducing a distortion that comes out along a contour, the sharpening filter process of sharpening a blurry image, and so on are listed.

In a case of outputting the upper hierarchy, the switch 108 inputs the lower hierarchical dummy decoded image 1007 into the simple filter 107. With the simple filter 107, a lower hierarchical pseudo decoded image 1009 is output. The lower hierarchical pseudo decoded image 1009, which is filed in the memory 104, is employed for later decoding.

So as to realize the simple filter, it is thinkable to make the tap length shorter than that of the foregoing high-quality imaging filter, and to simplify the arithmetic operation that the foregoing high-quality imaging filter performs, for example, to realize the arithmetic operation with an integral arithmetic operation. Further, it is thinkable to switch the degree of simplification of the high-quality imaging process for one part or the entirety of a frame responding to a characteristic quantity of image data such as a variance and a high frequency component.

Next, the entropy decoding unit 201, the inverse quantizing unit 202, and the inverse frequency converting unit 203 perform a process for the upper hierarchical data 2001, respectively, and create a prediction error signal 2004.

The prediction decoding unit 205 performs a prediction decoding process by making a reference to the lower hierarchical pseudo decoded image 1010 filed into the memory 104, and the upper hierarchical decoded image 2005 filed into the memory 204, and creates a prediction signal 2006. There exists the process of carrying out the up-sampling onto the resolution identical to that of the upper hierarchical decoded image as a prediction decoding process employing the lower hierarchical decoded image. By amplifying the upper hierarchical dummy decoded image 2007 obtained by adding the prediction signal 2006 and the prediction error signal 2004 by the filter 206, an upper hierarchical decoded image 2008, which becomes an output, is created. The upper hierarchical decoded image 2008, which is filed in the memory 204, is employed for later decoding.

In the above explanation, the specific example, which corresponded to the first embodiment of the present invention shown in FIG. 1, was described.

Additionally, in a specific example that corresponds to the second embodiment of the present invention shown in FIG. 3, the simple filter 107 of FIG. 5 is removed, and operation is executed with the lower hierarchical dummy decoded image 1007 regarded as the lower hierarchical pseudo decoded image 1009.

Further, in this example, the case that the number of the hierarchy was two was explained; however the present invention is also applicable to the case that the number of the hierarchy is three or more. In this case, the high-quality imaging filter is simplified in a hierarchy lower than the hierarchy that becomes an output.

In addition hereto, as apparent from the foregoing explanation, it is also possible to configure the present invention with hardware, and it is also possible to realize it with a computer program.

In this case, a program for allowing an operation similar to that of each section described above to be performed is filed into a program memory, and a processor, which operates under control of this program, performs a process similar to the foregoing example.

In this embodiment of the present invention explained above, the high-quality imaging filter process of the lower hierarchy is simplified or is not performed at all in outputting the upper hierarchy. In a case of outputting the lower hierarchy, various distortions of the decoded images greatly exert an influence upon a decline in a quality of the output image. However, in a case where the lower hierarchical decoded image is referenced in decoding the upper hierarchy, various distortions of the lower hierarchical decoded images do not exert an influence upon a decline in a quality of the output image relatively. In particular, in a case where the resolution of the lower hierarchy differs from that of the upper hierarchy, the distortion is attenuated owing to the magnifying process that is performed for the lower hierarchy, and hence the influence upon the image quality of the output image is alleviated.

Further, applying the present invention to the encoding device or technique, which correspond to the image decoding device or method, allows a decline in a quality of the output image to be suppressed furthermore.

By employing the simple filter for the lower hierarchical decoding process, which is locally performed in intra-encoding, in encoding the upper hierarchical image, the lower hierarchical decoded image, which is referenced in the upper hierarchy by the encoding side, coincides with the lower hierarchical decoded image, which is referenced in the upper hierarchy by the decoding side. This makes it possible to realize a reduction in the processing quantity of the image decoding device without bringing a large distortion to the upper hierarchical decoded image.

1. An image decoding method of decoding hierarchized image data, characterized in:
in decoding a lower hierarchy, amplifying a lower hierarchical dummy decoded image obtained by decoding lower hierarchical data by a filter to create a lower hierarchical decoded image; and
in decoding an upper hierarchy, amplifying said lower hierarchical dummy decoded image by a simple filter, being a filter obtained by simplifying said filter, to create a lower hierarchical pseudo decoded image, and thereafter decoding upper hierarchical decoding data by making a reference to said lower hierarchical pseudo decoded image.

2. The image decoding method according to claim 1, characterized in that the process of decoding one of the lower hierarchical data and the upper hierarchical data comprises:
a process of filing a decoded image; and
a prediction decoding process of performing prediction decoding by making a reference to said filed decoded image.

3. The image decoding method according to claim 1, characterized in that the filter smoothes boundaries of a block that becomes a unit for encoding image data.

4-6. (canceled)

7. An image decoding method of decoding hierarchized image data, said image decoding method comprising:
a step of filing a lower hierarchical decoded image into a first memory;
a first entropy decoding step of entropy-decoding lower hierarchical data:
a first inverse quantizing step of inverse-quantizing an output of said first entropy decoding step;
a first inverse frequency converting step of performing an inverse frequency conversion for an output of said first inverse quantizing step;
a first prediction decoding step of performing a prediction decoding process by making a reference to the image filed into said first memory and an output of said first inverse frequency converting step;
a first filter step of performing a filter process for an output of said first prediction decoding step, and outputting a lower hierarchical decoded image;
a simple filter step of performing a process of the filter, being a filter obtained by simplifying the first filter, for an output of said first prediction decoding step, and creating a lower hierarchical pseudo decoded image;
a step of inputting an output of said first prediction decoding step into one of said first filter and said simple filter by making a reference to a decoding hierarchy instruction signal, being a signal indicating whether or not the hierarchy being output is an upper hierarchy;
a step of filing an upper hierarchical decoded image into a second memory;
a second entropy decoding step of entropy-decoding upper hierarchical data:
a second inverse quantizing step of inverse-quantizing an output of said second entropy decoding step;
a second inverse frequency converting step of performing an inverse frequency conversion for an output of said second inverse quantizing step;
a second prediction decoding step of performing a prediction decoding process by making a reference to the lower hierarchical decoded image filed into said first memory, the upper hierarchical decoded image filed into said second memory and an output of said second inverse frequency converting step; and
a second filter step of performing a filter process for an output of said second prediction decoding step, characterized in:
in a case of assuming the lower hierarchical image to be an output image, outputting a lower hierarchical decoded image obtained by amplifying an output of said first prediction decoding step by said first filter, and filing it into said first memory; and
in a case of assuming the upper hierarchical image to be an output image, filing a lower hierarchical pseudo decoded image obtained by amplifying an output of said first prediction decoding step by said simple filter into said first memory, and making a reference hereto in the upper hierarchical decoding process.

8. (canceled)

9. An image decoding device for decoding hierarchized image data, characterized in comprising:
a means for, in decoding a lower hierarchy, amplifying a lower hierarchical dummy decoded image obtained by decoding a lower hierarchical data by a filter to create a lower hierarchical decoded image; and
a means for, in decoding an upper hierarchy, amplifying said lower hierarchical dummy decoded image by a simple filter, being a filter obtained by simplifying said filter, to create a lower hierarchical pseudo decoded image, and thereafter decoding upper hierarchical decoding data by making a reference to said lower hierarchical pseudo decoded image.

10. The image decoding device according to claim 9, characterized in comprising:
a memory for filing a decoded image; and
a prediction decoding unit for performing a prediction decoding process by making a reference to the decoded image filed in said memory.

11. The image decoding device according to claim 9, characterized in that said filter smoothes boundaries of a block that becomes a unit for encoding image data.

12-14. (canceled)

15. An image decoding device for decoding hierarchized image data, said image decoding device comprising:
a first memory for filing a lower hierarchical decoded image;
a first entropy decoding means for entropy-decoding lower hierarchical data:
a first inverse quantizing means for inverse-quantizing an output of said first entropy decoding means;
a first inverse frequency converting means for performing an inverse frequency conversion for an output of said first inverse quantizing means;
a first prediction decoding means for performing a prediction decoding process by making a reference to the image filed into said first memory and an output of said first inverse frequency converting means;
a first filter for performing a filter process for an output of said first prediction decoding means, and outputting a lower hierarchical decoded image;
a simple filter for performing a process of the filter, being a filter obtained by simplifying the first filter, for an output of said first prediction decoding means, and creating a lower hierarchical pseudo decoded image;
a switch for inputting an output of said first prediction decoding means into one of said first filter or said simple filter by making a reference to a decoding hierarchy instruction signal, being a signal indicating whether or not the hierarchy being output is an upper hierarchy;
a second memory for filing upper hierarchical decoded image;
a second entropy decoding means for entropy-decoding upper hierarchical data:
a second inverse quantizing means for inverse-quantizing an output of said second entropy decoding means;
a second inverse frequency converting means for performing an inverse frequency conversion for an output of said second inverse quantizing means;
a second prediction decoding means for performing a prediction decoding process by making a reference to the lower hierarchical decoded image filed into said first memory, the upper hierarchical decoded image filed into said second memory and an output of said second inverse frequency converting means; and
a second filter for performing a filter process for an output of said second prediction decoding means, characterized in:
in a case of assuming the lower hierarchical image to be an output image, outputting a lower hierarchical decoded image obtained by amplifying an output of said first prediction decoding means by said first filter, and filing it into said first memory; and
in a case of assuming the upper hierarchical image to be an output image, filing a lower hierarchical pseudo decoded image obtained by amplifying an output of said first prediction decoding means by said simple filter into said first memory, and making a reference hereto in the upper hierarchical decoding process.

16. (canceled)

17. A program of an image decoding device for decoding hierarchized image data, characterized in causing said image decoding device to execute:
a process of, in decoding a lower hierarchy, amplifying a lower hierarchical dummy decoded image obtained by decoding lower hierarchical data by a filter to create a lower hierarchical decoded image; and
a process of, in decoding an upper hierarchy, amplifying said lower hierarchical dummy decoded image by a simple filter, being a filter obtained by simplifying said filter, to create a lower hierarchical pseudo decoded image, and thereafter decoding upper hierarchical decoding data by making a reference to said lower hierarchical pseudo decoded image.

18. (canceled)

19. The image decoding method according to claim 2, characterized in that the filter smoothes boundaries of a block that becomes a unit for encoding image data.

20. The image decoding device according to claim 10, characterized in that said filter smoothes boundaries of a block that becomes a unit for encoding image data.
